(19) United States
(12) Patent Application Publication
(10) Pub. No.: US 2020/0104381 A1
(43) Pub. Date: Apr. 2, 2020

(54) MICRO-SITE GENERATION AND EMBEDDING USING TEMPLATES

(71) Applicant: IPTV Brands Limited, London (GB)

(72) Inventors: Craig Paul Norris, West Midland (GB); Jamie Brian Morris Martin, Hampshire (GB)

(21) Appl. No.: 16/145,340

(22) Filed: Sep. 28, 2018

(51) Int. Cl. G06F 17/30; G06F 17/24; G06Q 10/06; H04L 12/26; G06Q 30/02

(52) U.S. Cl. CPC G06F 17/3089; G06F 17/248; G06Q 30/0202; G06Q 10/0631; H04L 43/0876; G06F 17/30873

(57) ABSTRACT

An event system comprises an admin application, a producer application, a micro-site, an embedded version of the micro-site, a database, and a portal. Templates are used to generate a micro-site for an event. The event is promoting a product on the micro-site according to a schedule. The micro-site is accessible via another website during the scheduled time. The admin application is configured to receive an order for the product. A portal configured to receive information about the order for the product and transmit the information for fulfilment. The database is configured to store the schedule and the information about the order. The producer application is configured to receive, from the admin application, micro-site and embedded version views, stock allocations and sales data of the product being promoted while the event is running.

### BACKGROUND

TV shopping companies typically invest in their own bespoke system infrastructure due to the complexities of how the businesses work and, therefore, there being a lack of off-the-shelf solutions. These TV shopping companies implement one bespoke commerce system and integrate the order-taking into their single in-house fulfilment system. Such systems are expensive, complex, and are difficult to modify.

Those TV shopping companies that have not invested in their own system technology have many challenges, such as not being able to have real time sales demand data, needing separate stock allocated for non-integrated call center and website systems, and needing many separate systems where additional staff are needed because the separate systems are not able to communicate with each other thus resulting in a poor customer service experience and ultimately low customer lifetime value.

### SUMMARY

An event system comprises an admin application, a producer application, an API (application programming interface), a micro-site, third party integrations, a database, and a portal. Templates are utilized to generate a micro-site and/or a JavaScript tag to embed into a user (e.g., seller) website's look and feel for an event. The event is promoting a range of products on the micro-site or the user's own website with the event UI (user interface) embedded according to a schedule. The micro-site or embedded version of the micro-site is accessible via another website during the scheduled time or via the user's own site. The templates enable the micro-site or the embedded version of the micro-site to take on the appearance of many other websites. The admin application primarily is a UI to configure orders to be received for products. A portal is configured to display and receive information about the order for the product and transmit the information for fulfilment. The database is configured to store the schedule and the information about the order, amongst many stored information and configurations. The producer application is configured to receive, from the admin application, stock allocations and sales data of the product being promoted while the event is running.

In an implementation, an event system comprises an admin application, a portal, and a database. The admin application comprises a plurality of templates and is configured to generate a micro-site or an embedded micro-site for an event using the templates as configured by a user device, wherein the micro-site or the embedded micro-site is accessible via a user website during a scheduled time, and wherein the admin application is configured to receive an order for a product. The portal is configured to receive information about the order for the product and transmit the information to a user device for fulfilment. The database is configured to store the schedule and the information about the order.

In an implementation, an event method comprises receiving product information for an event at an event promotion system; creating a micro-site or an embedded micro-site for the event at the event promotion system using the product information, wherein the event is live promotion of a product, and wherein the micro-site or the embedded micro-site is controlled by the event promotion system and appears as a user website to a user accessing the user website; running the event over the micro-site or the embedded micro-site, wherein the event is accessible via the user website and via social media; receiving an order for the product over the micro-site or the embedded micro-site while the event is running; processing the order at the event promotion system; and outputting information about the order to a user device through a portal.

In an implementation, a system for promoting an event comprises: a processor for generating a micro-site for an event using product information and layout information received from a user device, wherein the micro-site is separate from, but accessible by, a user website and wherein the micro-site appears to be the user website to a user device that accesses the event through the user website or through social media; and a memory for storing the schedule for the event.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for promoting an event;

FIG. 2 is an operational flow of an implementation of a method for promoting an event;

FIG. 3 is an operational flow of an implementation of a method for setting up an event for promotion;

FIG. 4 is a diagram of an example template that may be used in setting up an event for promotion;

FIG. 5 is a diagram of example event data;

FIG. 6 is an operational flow of an implementation of a method of making a purchase during a promoted event;

FIG. 7 is an operational flow of an implementation of a method of using a fixed price model for a promoted event;

FIG. 8 is an operational flow of an implementation of a method of using a falling auction model for a promoted event; and

FIG. 9 shows an exemplary computing environment in which example embodiments and aspects may be implemented.

### DETAILED DESCRIPTION

An event, such as a live or pre-recorded home shopping sales event for a product or service by a user (e.g., a seller), is generated and promoted, and played over a website and/or a TV channel and social media outlets. The user may be a retailer, a wholesaler, or any entity, brand or individual that has a product or service that they would like to sell. In an implementation, a promoted event is a paid advertised event by a user for an event promotion system to host a live streamed sales event with the ability for a client (e.g., a buyer) to purchase the current product being shown on screen. The event may be produced live in a studio with associated cameras, lighting, guests, presenters, models, product specialists and one or more products for sale. The event may also be produced anywhere using just a video camera. The user promotes the event in advance to its existing customer base (e.g., by placing a banner on their website, a post on social media or search engine marketing with a link to a site created and managed by the event promotion system). The event promotion system may also promote the event on a TV channel. Although the event promotion system plays the promoted event over its own website, it may also stream the event elsewhere, such as onto the user's website. A stream is the live video stream that features on the user's sales event page. The live stream for use over the internet can be viewed by many people using a content delivery network.

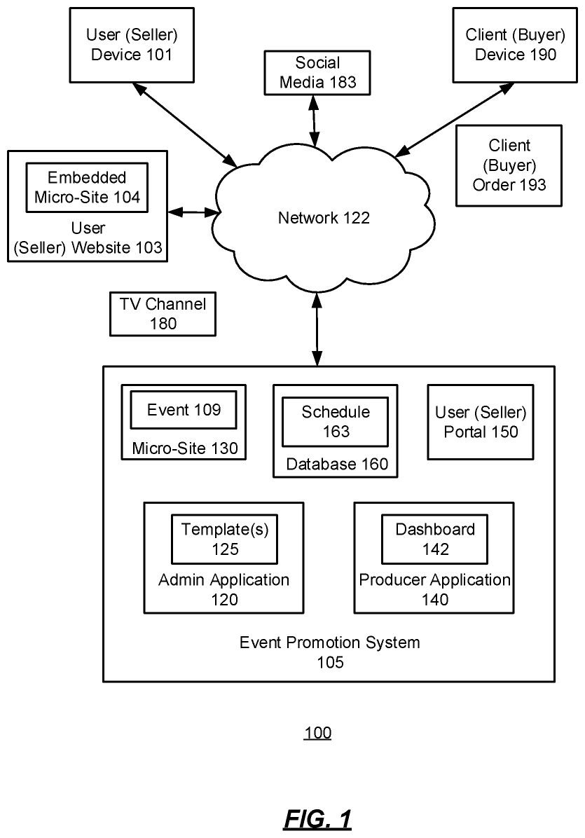

FIG. 1 is an illustration of an exemplary environment 100 for promoting an event. The environment 100 may include an event promotion system 105, a user (seller) device 101, and a client (buyer) device 190 in communication through a network 122. The network 122 may be a variety of network types including the public switched telephone network (PSTN), a cellular telephone network, and a packet switched network (e.g., the Internet). Although only one user device 101 and one client device 190 are shown in FIG. 1, there is no limit to the number of user devices and client devices that may be supported.

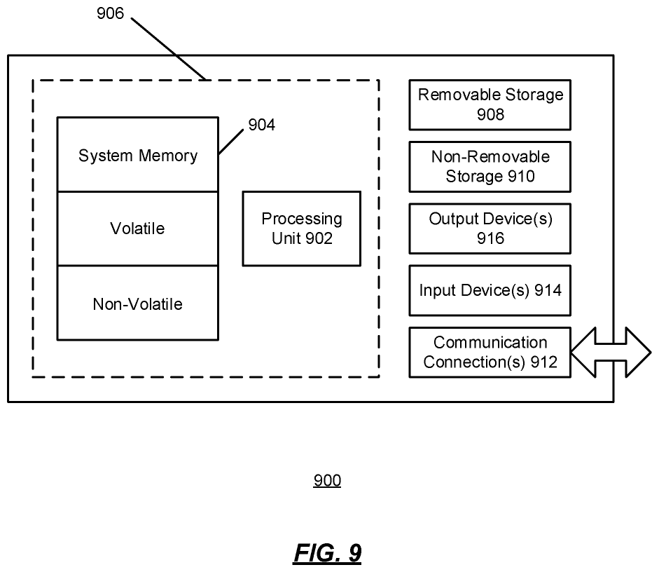

The user device 101, the event promotion system 105, and the client device 190 may each be implemented using a variety of computing devices such as smartphones, desktop computers, laptop computers, tablets, digital media player, set top boxes, vehicle navigation systems, and video game consoles. Other types of computing devices may be supported. A suitable computing device is illustrated in FIG. 9 as the computing device 900.

The user device 101 provides product information (e.g., description, pricing, quantity) to the event promotion system 105, which creates the event 109, promotes the event 109, and runs the promoted event 109, as described further herein.

The event promotion system 105 may comprise a website, referred to as the micro-site 130, in which a client can buy a product and checkout using the client device 190. Depending on the implementation, the event may be accessible by one or more of a TV channel 180, social media 183, or a user website 103. Alternatively or additionally, an embedded version of the micro-site, referred to as an embedded micro-site 104, may be provided on the user website 103. In an implementation, a JavaScript tag may be embedded into the user website 103 so that the sales of the event 109 are handled on the user website (not the micro-site 130), while the client order 193 data is still provided to the event promotion system 105.

The event promotion system 105 generates the elements for the micro-site 130 or the embedded micro-site 104 for the event 109 so that the micro-site 130 and the embedded micro-site 104 look and feel like the user website 103. The event promotion system 105 receives client orders 193 from the client device 190, processes the client orders 193, and sends client order information to the user device 101 for fulfillment by the user.

A client accesses the promoted event 109 using the client device 190 through the micro-site 130, either directly or via a system TV channel 180, the user website 103, or social media 183, and places a client order 193.

On the lead up to the promoted event 109, the user device 101 may place a banner or a graphic on the user website 103 which links through to the event micro-site 130 created and managed by the event promotion system 105. The micro-site 130 or the embedded micro-site 104 features an event video stream and a list of products for sale during the promoted event 109. If the promoted event 109 is not yet live, the micro-site 130 or the embedded micro-site 104 will display a countdown to the promoted event 109, with the facility for the client device 190 to pre-register an account to use for subsequent purchase. The event promotion system 105 can generate multiple micro-sites such that it can easily create one which will look and feel just like the user website 103. In this manner, the client may be unaware that they have left the user website 103 and actually been passed on to the platform of the event promotion system 105. Once the promoted event 109 takes place, the client device 190 transacts on the system micro-site 130 or the embedded micro-site 104 and receives an order confirmation from the event promotion system 105. A client will be able to view their event orders in their My Account area of the system micro-site 130 or the embedded micro-site 104 using the client device 190. Once the promoted event 109 has concluded, the client data and order data is passed to the user device 101 for the user to fulfill the order through their usual fulfilment methods.

The event promotion system 105 further comprises an admin application 120, a producer application 140, and a user (seller) portal 150. A database 160 (e.g., a central SQL server database) is also provided.

The admin application 120 provides set up of various components of the system 105, such as set up of the event 109 and set up of the micro-site 130 or the embedded micro-site 104, as well as inventory and stock control, for example. Once the product data has been loaded for the event 109, a schedule 163 (running order) of products is created with the products from the user that will form the event (when the event 109 will comprise multiple different products being offered for sale one at a time). The schedule 163 may be saved to the database 160 and/or provided to the producer application 140.

The producer application 140 provides technical interactivity between various components of the system 105 and comprises a dashboard 142 that may display or otherwise output information to a producer of the event 109. In an implementation, the producer is a person in control of the event sales, who monitors product stock allocations in real time. Alternately, the producer application 140 can monitor product stock allocations and perform other duties, such as adjusting the schedule of products during the event 109 and adjust the price and timing of products being sold during the event 109.

The user portal 150 provides output data to the user, such as products sold, pricing information, invoicing information, client contact information, etc., in various formats.

Once the event 109 is live, stock reservation and sales data is reported to the producer application 140, which can use this data (alone or in conjunction with a producer, depending on the implementation) to adjust how the event proceeds. The producer application 140 can re-order the products to be offered for sale within the event on the fly, which in turn will update the micro-site 130 or the embedded micro-site 104. For example, the producer application 140 (or a producer via the producer application 140) may notice that a particular upcoming product is receiving a lot of clicks/attention and therefore may decide to move it up in the running order to be offered for sale sooner in the event 109. The producer application 140 also drives the onscreen/TV graphics hardware, which triggers the onscreen details to be populated or animated on the micro-site 130 or the embedded micro-site 104 at the appropriate time.

Thus, the producer application 140 (or a producer via the producer application 140) uses the sales and reservation data to make decisions on how the event 109 will continue. The schedule 163 created within the admin application 120, and stored in the database application 160, is loaded in to the producer application 140. The producer application 140 may receive in real time the number of visitors to the micro-site 130 or the embedded micro-site 104 that the event 109 has, along with the number of reservations to shopping carts in real time of the product on sale. A separate number is also recorded for the number of hits on other products that are upcoming in the event 109. The producer application 140 receives these numbers within a second or two of the product either being added to cart or clicked on for more information. A sales tally tracks the value of products in carts ‘yet to be checked out’, and the value of checked out orders, so that the producer application 140 can guide the presenter of the product on the micro-site 130 or the embedded micro-site 104 accordingly to encourage viewers to checkout. The producer application 140 may also display a list of names and locations of those buyers (clients) that have the current item in reservation, so that either the presenter can add some personal interaction to those names, or the names can be sent to the an on-screen graphics generator to scroll across the live stream on the micro-site 130 or the embedded micro-site 104.

The producer application 140 not only shows the producer the current sales and stock availability of all the products in the event 109, it also gathers product hits, i.e., a continuous hit counter of when users click on upcoming products within the event 109 to see more information about that product. This ‘click’ is interpreted as ‘interest’ in the item, so the producer application 140 can provide an indication as to which event products might be popular, giving the producer application 140 (or a producer) the opportunity to change the event schedule 163 or react on pricing accordingly.

The dashboard 142 allows the producer to select an event Id. From that point, because the relevant system ID numbers are stored within an eventID record in the database 160, the correct ScheduleID can be retrieved and then the list of event products is displayed to the producer or otherwise provided to the producer application 140. The producer or the producer application 140 can still re-order the products in to a different running order if it is determined or estimated that another running order would positively influence sales.

The producer application 140 triggers procedures stored within the database 160, such as calculating how many of the user's products are currently in allocation or have successfully checked out and are paid for. These statistics may be provided to the producer application 140 and refreshed regularly (e.g., every 5 seconds, etc.) so that the producer and/or the producer application 140 can gauge in almost real time how many of the products for sale are being added to online carts and therefore make decisions about which product to sell next, and how to allocate retail time. Each click of a product by a user to see the information, may also be recorded in the database 160, so that the producer application 140 and/or the producer can determine which upcoming products will likely be most in demand.

In an implementation, when a client adds a product to a cart on the micro-site 130 or the embedded micro-site 104, a product reservation record is created in the database 160, and the stock availability is deducted in real time. The producer application 140 calls the database 160 stored procedure to return latest sales and allocation figures. The stored procedure outputs sales revenue and item allocation/order count. The producer application 140 receives this data from the database 160 and may display this information on the dashboard 142 or otherwise output the information. The producer and/or the producer application 140 can use statistics to decide how much more time to allocate to current product for sale (e.g., dipping sales mean to move on to next product on the schedule 163).

The producer application 140 can trigger pre-built animations on screen, using any type of broadcast graphics and playout technology solution. The producer application 140 formats data into the proper format to push data in to the data fields within the graphics layout to be displayed on the micro-site or the embedded micro-site 104. An example is pushing the product title and price to the right field numbers via a class object, which places that product title and price into the right place.

Because the promoted event 109 is live, data regarding stock levels and stock moving in or out of shopping carts is monitored and used in real time. The system 105 uses reservations in which a product being sold is allocated exclusively to that client for a short period of time allowing the client to check out. The system also allocates ‘live stock’ to the client that is placing it in their shopping cart, meaning that if the client has it in their cart, they can complete the checkout process knowing they have that product reserved for them.

When a product is added to cart, a ‘reservation’ is created for this product. Each new cart has a unique ID number assigned to it. When a product is added to a cart, a new entry is made in a reservation database table referencing the unique cart identifier and the system ID of the product. When displaying the cart contents, the various database scripts list the products with the same unique cart ID. Once the reservation has been created, the stock quantity of the item is then deducted in real time, by the cart quantity. When the producer application 140 reports in real time, it looks for associated reservations/allocations for the products within the event 109, and the sales for the products within the event 109.

Reservations have an associated expiry date/time, which means that, should that product not be converted from a reservation into an order, then the product is returned to stock and the reservation is marked as inactive. On returning the product(s) in the reservation to stock, the stock levels are adjusted and subsequently another client could now add the stock to their own reservation.

An order is created from a reservation. Orders are created once successful payment has been received. If payment is not successful, the reservation expiry date/time is extended to allow the client to reattempt payment. If payment is then still not successful, or the client abandons their shopping cart, once the reservation expires, the reservation contents are returned to stock.

The micro-site 130 and the embedded micro-site 104 are designed to be as fast and as programmatically light weight as possible. The client may enter the event 109 through the user website 103 and is passed through to the system 105 via a promoted image, a social media post, a search engine marketing advertisement, an affiliate, or a banner. Once through to the events page, either a countdown to the event 109 is displayed with the ability to pre-register for a client account, or if the event 109 has started, the list of upcoming products along with the featured item and video stream are visible on the micro-site 130 or the embedded micro-site 104. The micro-site 130 and the embedded micro-site 104 takes advantage of caching server data to minimize calls to the database 160 to improve performance.

On conclusion of the event, the user is able to download the client data and order data in common CSV and XML formats through logging in to the user portal 150. The user portal 150 may list the orders that have been placed in the event 109, and the user may be able to action a refund to the client should the client order be returned.

Thus, depending on the implementation, features of the system 105 include real time stock allocation data, video integration to the most popular social media platforms, and automated processes eliminating the need for human interaction.

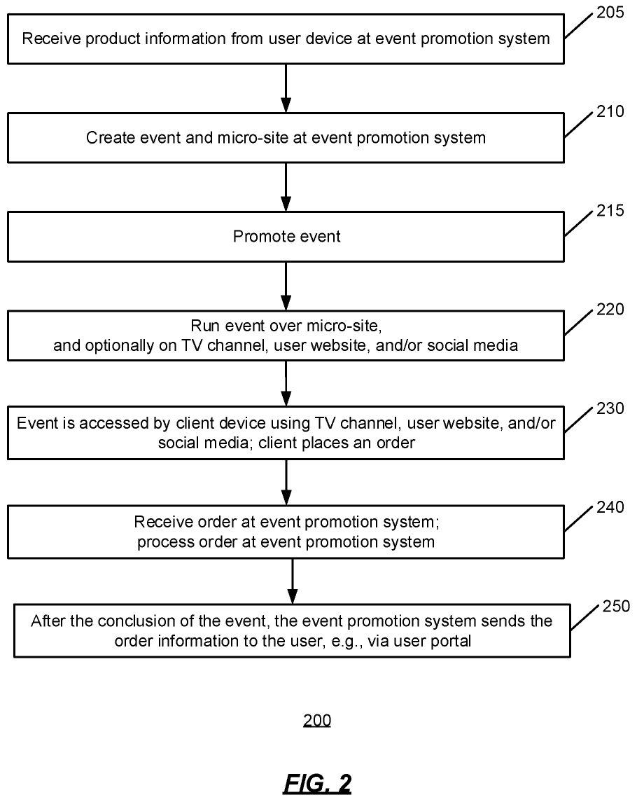

FIG. 2 is an operational flow of an implementation of a method 200 for promoting an event. At 205, the user sends the product information, such as SKU data and pricing, to the event promotion system 105 such as via the user device 101 for example, where it is received by the event promotion system 105. At 210, the event promotion system 105 creates an event 109 along with a micro-site 130 or the embedded micro-site 104.

At 215, the event 109 is promoted by the event promotion system 105 and/or by the user. The user may promote the event by emailing a database of customers and/or prospective customers, and/or by posting information via social media 183 or the user website 103, for example.

At 220, the event 109 is run over the micro-site 130 (e.g., as a live branded event for the user, e.g., with a producer, presenter, crew, studio, cameras, lighting, etc. depending on the implementation) or the embedded micro-site 104, which may be accessible directly or via the user website 103 or social media 183. In an implementation, the user can also run a live event using just a camera. Alternatively or additionally, the event 109 may be played on a TV channel 180, such as a TV channel of, or associated with, the event promotion system 105. Thus, the event 109 may be streamed to the user website 103, to social media 183, and/or to one or more TV channels 180.

At 230, a client accesses the event 109 via the client device 190. In an implementation, the client may access the event 109 by clicking on the user website 103, by clicking on the event on social media 183, or by viewing the event 109 on a TV channel 180 that is playing the event 109. The client, via the client device 190, is passed to the micro-site 130 or the embedded micro-site 104 which appears to be the user website 103. The client places an order on the micro-site 130 or the embedded micro-site 104. The client transacts on the micro-site 130 or the embedded micro-site 104. At 240, the event promotion system 105 receives the order. The event promotion system 105 processes the order (e.g., processes payment, sends funds to user). Any payment processor may be used, such as Stripe.

At 250, after the conclusion of the event 109, the event promotion system 105 sends the order information (client name, address, product identifier, etc.) to the user for fulfilment. The order information may be provided to user device 101 via the user portal 150. The event promotion system 105 can supply client and order data to the user via a common CSV or XML format that the user's system can readily absorb, process, and send for dispatch.

In an implementation, the event promotion system 105 provides at least two options to provide data to the user for fulfilment: CSV file export and a user portal 150. For CSV file export, the data is supplied using data fields in CSV format to enable the user to fulfil the order to the client. Example order data that may be exported in CSV formatted data fields includes client name, address, postcode, item ordered, sale price, quantity, postage price paid, etc. The data can either be returned in a way to match a supplied CSV format preferred by the user (to minimize any integration for import into the user's ordering system) or in a predetermined format that would be adequate for most existing ordering systems, however this option might require some manual intervention by the user using a CSV editor before it could be imported in to the user's ordering software. Either file format can be securely transmitted by either passworded email attachment or SFTP (SSH file transfer protocol) to the user, in an implementation.

Alternately or additionally, the user may download the file using the user portal 150. With this option, the user can log into the user portal 150 and download their orders as pre-made PDF dispatch notes for example, complete with integrated shipping labels. With this technique, the system 105 may use the user's own courier accounts, or may bill the user for shipping and therefore use the system's own courier accounts. The user downloads PDF files containing pick sheets and client copy dispatch notes to fulfil the orders from within their own warehouse. The system 105 interprets each order and outputs the data in to an order template, which is then converted to a PDF document. The dispatch portal 150 has the ability to join multiple order PDF files in to a single downloadable PDF file, meaning the user can download hundreds of orders within one file. Once the set number of orders has been downloaded (e.g., if set to 500 orders per file), the remaining orders would follow in a secondary PDF file.

The event promotion system 105 allows the user to ‘build’ their own version of how their event page will look during their sales event 109, by choosing from a range of pre-existing header, video, product grid and footer layouts, to get a look and feel as close to their existing website (the user website 103) as possible. Once the base design (a template web page that is subsequently customized) has been selected, the micro-site 130 and the embedded micro-site 104 is built in such a way that an overriding CSS (cascading style sheets) file is used to contain all of the personalization to make the promoted event 109 micro-site 130 and the embedded micro-site 104 mirror the look and feel of the user. This includes matching the user's color scheme, call to action wording, same checkout/cart icons, fonts, and anything else to so that the client still feels that they are shopping with the user directly, but they are in fact on the system 105.

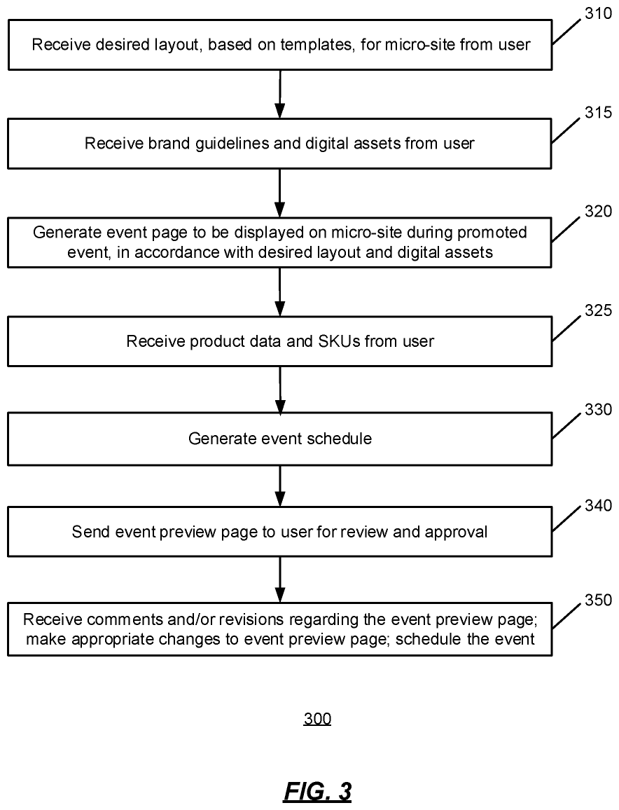

FIG. 3 is an operational flow of an implementation of a method 300 for setting up an event for promotion. At 310, the user determines a desired layout of the event page to be displayed on the micro-site 130 or the embedded micro-site 104, e.g., using one or more templates 125 provided by the system 105 (within the admin application 120, for example), and provides the desired layout to the system 105 where it is received. The system 105 may store a number of templates 125 for different areas of the micro-site 130 or the embedded micro-site 104, for example, that each user can choose from, including headers, video section, product grid, footer, and product information areas, etc. The user can manually make design changes if desired to the template they select.

Once ‘look and feel’ has been decided, the template(s) may be further customized with CSS overrides, so that the color scheme is such to match the user's own website (e.g., the user website 103). This is where the admin application 120 can match up icons, colors, and fonts to give an end user (e.g., a client) the feel that they are still transacting on the user website 103. Each of these customizations are then stored against a userID (the user, e.g., the seller) within the database 160.

At 315, the seller provides the system 105 with brand guidelines and relevant digital assets. At 320, the system 105 generates the event page (which will be displayed on the event micro-site 130 or the embedded micro-site 104 during the promoted event 109) in accordance with the desired layout and the digital assets (e.g., to mimic the user website 103 look and feel). The system 105 stores the event display settings e.g., in the database 160.

On creating an event, the fields entered on the setup form are stored within the database 160, and the micro-site 130 or the embedded micro-site 104 then recognizes that it will use the selected template for the header area, the selected template for the video area, the selected template for the product grid, the selected template for the footer and the selected template for the product information area, and dynamically changes to fetch the relevant CSS template to output the page within the user's browser.

At 325, the user provides the system 105 with the product data and SKU's. In an implementation, once the event 109 has been created within the system 105, the user's product data is entered into the admin application 120, and set up as individual SKUs. Standard data fields are captured at this point including product title, product description, cost price, was/now price to client, category, product image upload, etc. Bundles may be created from groups of SKUs not normally grouped on the user device 101.

In an implementation, the system 105 uses a combination of ID numbers to join the various data together to output the event data used to drive the event 109. Each event 109 has an eventID, which has an associated userID, channelID (the broadcast channel of the event, meaning multiple events can be run simultaneously), event start/end date and time. Each event 109 is also linked to a default currency; for example, a British user may only want to sell in £GBP, have their product descriptions in British English, and only ship within the UK, so each event stores the default currencyID, countryID, and languageID. On an event by event basis, multi-currency, multi-language, and multi-country options can be enabled, meaning the micro-site 130 or the embedded micro-site 104 will still default to the selected currency/language/country, but the end user (the client) can change these settings on the website should they wish to pay in $USD for example.

At 330, the system 105 builds the event schedule within the admin application 120 (e.g., stores the user name or ID, the start time, the end time, and event settings in the SQL server database 160). In an implementation, the admin application 120 allows a user to find the products associated with the user and schedule them into a running order for a schedule 163, which will be the selling order for the event 109. Alternatively, the admin application 120 itself may generate the schedule 163 without user intervention. Each schedule 163 has its own scheduleID, and then on saving the list of products, this scheduleID is saved against the eventID for later loading in the producer application 140.

At 340, the system 105 sends the user a private link to the event preview page for review and approval. At 350, the user approves or provides comments and/or revisions to the system 105 regarding the event preview page. The system 105 makes any changes and schedules the event 109.

When a client visits the event page on the micro-site 130 or the embedded micro-site 104, the admin application 120 checks that the eventID within the URL is active within the system 105, and either shows the “coming soon” page if the event 109 has not started, the “event expired” page if the event 109 has passed, or the full event page and associated templates and styles if the event 109 is active. If the event is active, then the products are loaded from the relevant scheduleID and displayed on the page in the micro-site 130 or the embedded micro-site 104.

To embed the micro-site 130, the user places an image, banner, or text link on the user website 103, with a link through to the URL supplied by the system 105. Each event URL is unique by event. Once the client clicks through from the user website 103, the event micro-site 130 opens within a new browser tab on the client device 190 or in the case of the embedded micro-site 104 will appear on the user website 103. From the client's point of view, they are now looking at a website that still has the same look and feel as the user website 103 and has the user's logo present, along with the elements provided by the system 105 such as the video stream and the upcoming products.

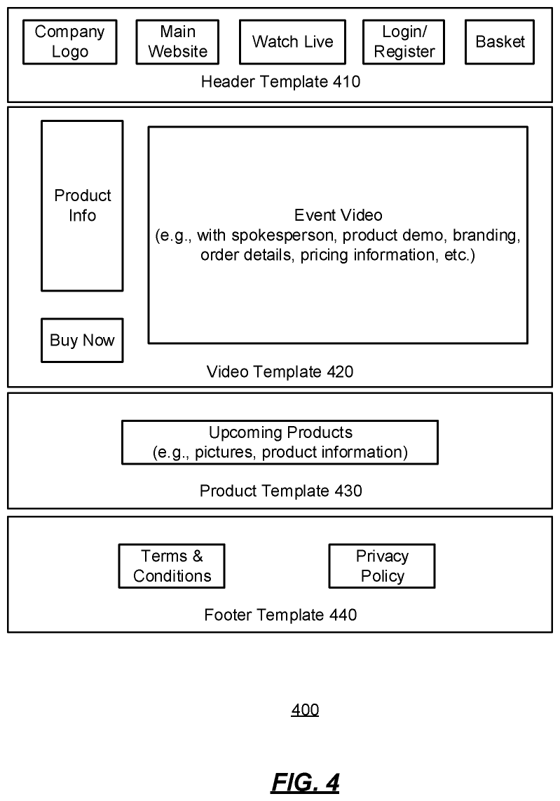

FIG. 4 is a diagram of an example template that may be used in setting up an event for promotion. The template may be similar to the template 125 described above. In an implementation, the template, shown in FIG. 4 as a template 400, may comprise various templates that a user may interact with via the user device, to select an event page layout for use with the micro-site 130 or the embedded micro-site 104. Templates may include a header template 410, a video template 420, a product template 430, and a footer template 440. The template 400 is not limited to these various templates, and other templates are contemplated and may be incorporated, depending on the implementation.

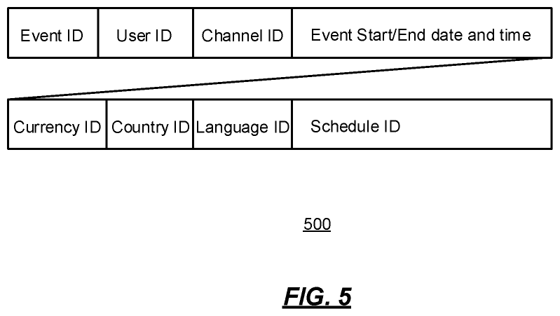

FIG. 5 is a diagram of example event data 500. As described further herein, the event data 500 may be comprise data such as the event ID, the user ID, the channel ID, the event start and end date and time, the currency ID, the country ID, the language ID, and schedule ID. Additional and/or different data may be stored as the event data 500. The event data 500 may be stored in storage or a memory, such as the database 160.

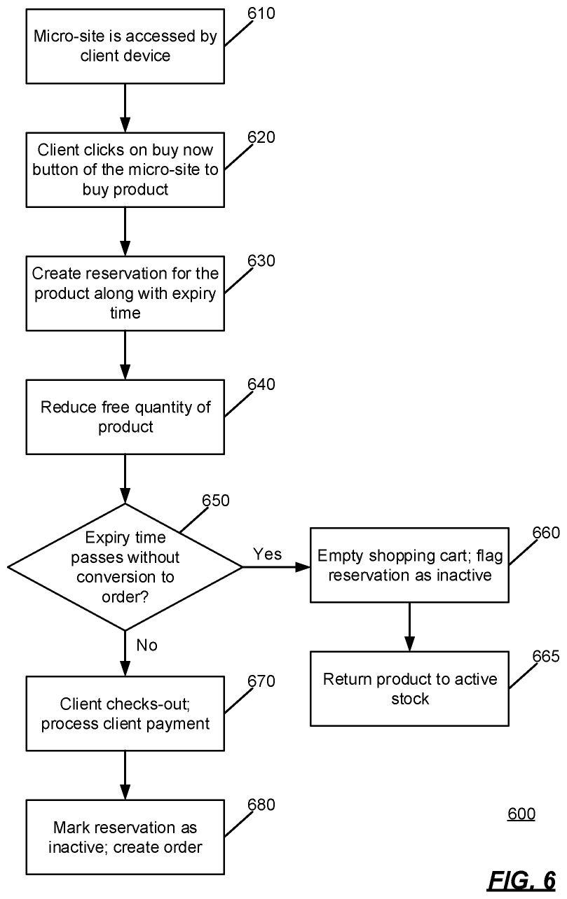

FIG. 6 is an operational flow of an implementation of a method 600 of making a purchase during a promoted event. At 610, the event page of the micro-site 130 or the embedded micro-site 104 is accessed by the client device 190. The active ‘on-air’ product is displayed into the primary sales position on the micro-site 130 or the embedded micro-site 104, and upcoming products in this event 109 may also be displayed on the page on the micro-site 130 or the embedded micro-site 104.

At 620, the client clicks on a buy now button on the micro-site 130 or the embedded micro-site 104 associated with the active on-air product. If on-air item has multiple variations available, example, sizes or colors, a pop-up allows the client to choose which variation they would like.

At 630, a reservation is created, if no active reservation already exists for this website session, along with a predetermined expiry time (e.g., 10 minutes, 20 minutes, etc.). This expiration time may be increased with additional products added to cart, or when the checkout process is started. At 640, when a product is added to a reservation, the free quantity of that product within the system 105 is reduced by the number added to the shopping cart.

At 650, if the reservation expiry time is passed without the reservation successfully being converted in to an order, at 660, the shopping cart is emptied, and the reservation and reservation items are flagged as inactive. At 665, a database agent job returns the cart contents back in to active stock, so that these items are available for allocation again.

When a client decides they want to check-out, they move in to the check-out process at 670. Any known method of payment and processing may be used, such as paying with a credit card via Stripe for example. If the payment is a success, then the reservation is marked as inactive and the order is created at 680. The reservation and order contain the same information, such as client ID, billing/shipping_address ID, currency ID, language ID, and country ID. The reservations and orders tables within the database 160 then have separate tables called ‘reservations items’ and ‘orders items’, each detailing the products being ordered, along with selling price, quantity, and cost price etc. The reservation_items are marked as inactive, and the orders_items are marked as active, effectively ‘moving’ the reserved stock from a reservation to an order. On completion of an order, the client can then navigate back to the live event page of the micro-site 130 or the embedded micro-site 104.

Because it is known what products are included in each event, and the start and end date/time of each event are known, the database 160 can be queried for order records of a particular list of products ordered between a date range. Therefore, for any given eventID, the list of products scheduled for that event may be obtained, and the database 160 may be queried for sales records of these products ordered during the event 109.

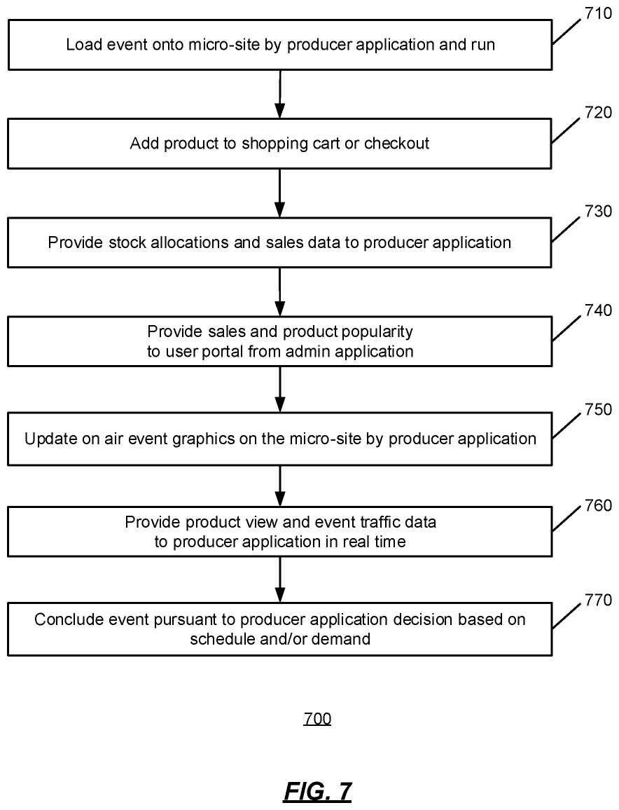

FIG. 7 is an operational flow of an implementation of a method 700 of using a fixed price model for a promoted event. The fixed price model is a traditional method of selling a product with ‘was’ and ‘now’ prices to show a special offer during the event 109. Clients purchasing products with this format all pay the ‘now’ price.

At 710, the event 109 is loaded onto the micro-site 130 or the embedded micro-site 104 by the producer application 140 and run live. At 720, a client adds a product to their shopping cart or completes the checkout process. At 730, the stock allocations and sales data are provided from the admin application 120 to the producer application 140 in real time. At 740, the sales and product popularity are provided in real time to the user portal 150 by the admin application 120. At 750, the on air event graphics on the micro-site 130 or the embedded micro-site 104 are updated by the producer application 140 with remaining stock or call to action.

At 760, product view and event traffic data is gathered by the admin application 120 and provided to the producer application 140 in real time. In an implementation, embedded within the website is the Google Analytics code and unique Google reference number assigned by Google. Using Google Analytics, it is possible to view the number of viewers on the micro-site 130 or the embedded micro-site 104 at any given time, along with the source of the viewer. The admin application 120 may use the login credentials to the Google Analytics API, and retrieve the data from Google regarding the number of clients on the event micro-site 130 or the embedded micro-site 104. This information may be stored in the system's database 160 along with a date stamp. This data can be represented to the producer (e.g., in graphical form) within the producer application 140 to give the producer a feel for how busy the event is. At 770, the event 109 concludes pursuant to a producer application 140 decision based on schedule and/or demand (e.g., if the schedule ends or the demand decreases below a threshold).

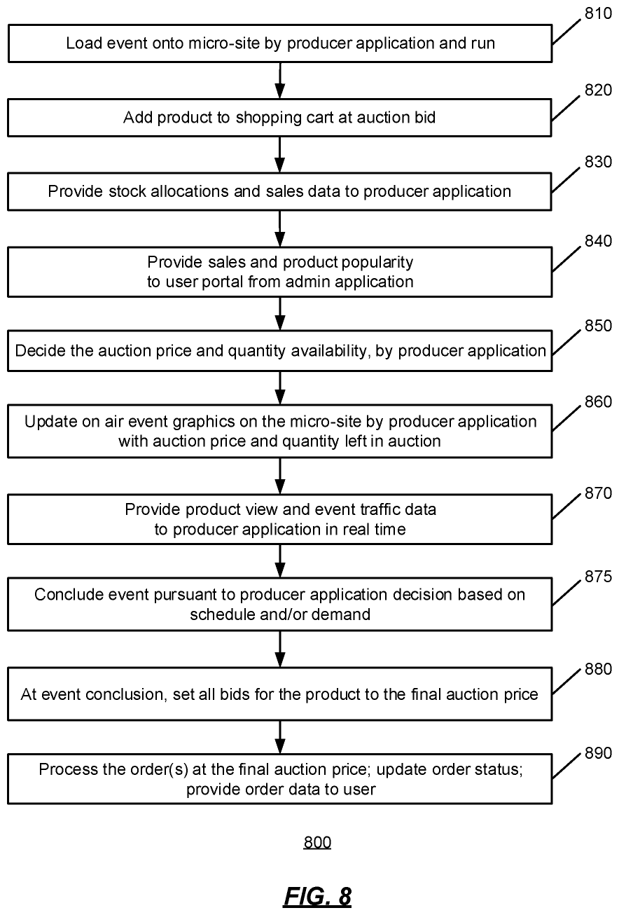

FIG. 8 is an operational flow of an implementation of a method 800 of using a falling auction model for a promoted event. The falling auction (also referred to as the reverse auction format) is a method of selling a product which is initially on sale at a ‘start price’, and then the producer lowers the current price of the product on offer in small or large decrements, forming the ‘now at’ price. Clients place the item in their shopping cart, which are reserved for them at the current ‘now at’ price. The producer can continue discounting the product. The producer may at their discretion also display a ‘quantity’ number to the client which appears on the stream or the event page, meaning the client needs to reserve their item before the quantity remaining runs out. Once the producer takes the prices to the price that they wish to close the auction at (this price is deduced by demand), then the auction is ended, at which point all reservations for this product are re-priced to the ‘final closing price’, meaning no matter what price the client first reserved the product at, they are only billed the final price at the conclusion of the event.

Thus, at 810, the event 109 is loaded onto the micro-site 130 or the embedded micro-site 104 by the producer application 140 and run live. At 820, a client adds a product to their shopping cart via placing an auction bid. At 830, the stock allocations and sales data are provided from the admin application 120 to the producer application 140 in real time. At 840, the sales and product popularity are provided in real time to the user portal 150 by the admin application 120. At 850, the producer application 140 (or the producer via the producer application 140) decides the auction price and quantity availability based on demand.

At 860, the on air event graphics on the micro-site 130 or the embedded micro-site 104 are updated by the producer application 140 with auction price and quantity left in auction. The on air product is the current product that is being demonstrated within the event 109. Only this product is for sale. All other products are displayed as “upcoming products” and only available to purchase when being demonstrated.

At 870, product view and event traffic data is gathered by the admin application 120 and provided to the producer application 140 in real time. At 875, the event 109 concludes pursuant to a producer application 140 decision based on schedule and/or demand (e.g., if the schedule ends or the demand decreases below a threshold). At 880, at the event conclusion, all bids for the product are set by admin application 120 to the final auction price. At 890, the system 105 (e.g., the admin application 120) processes the order(s) at the final price. After the event concludes, the payments for the orders are taken by the system 105 and the order status is updated. The order data is provided to the user who then fulfils the order.

Multiple events for different users can be run simultaneously. Because the system 105 uses an eventID number, which is unique, it is possible to keep everything separate. Each eventID can only be linked to a single scheduleID (a list of products within the event). Each event can have its own layout and micro-site or embedded micro-site, and each user has its own CSS overrides allowing custom fonts, colors, icons etc. Because the combination across the system 105 of eventID, userID (user or seller), scheduleID is unique, it is possible to have an unlimited number of events active at the same time—the only limit being the capacity of system 105. Because each running version of the producer application 140 focuses only on a single eventID, all sales information can be retrieved for that event only.

As described, the unique combination of the eventID with scheduleID and userID (user or seller) allows the producer application 140 to only report on the relevant event. The eventID is consistent through the admin application 120, the producer application 140, and the user portal 150. Each shopping cart has a unique ID, which links back to the eventID that it was created with, meaning all carts (and thus all orders) can be differentiated. Moreover, because of the use of these various identifiers, separate merchant accounts are not needed for each user, although for commercial reasons may be applied.

When a new shopping cart record is created within the database 160, it is assigned a unique ID along with the eventID. The queries on the database 160 are based on eventID within the producer application 140, meaning sales/allocations are only reported for the correct event, even if there are multiple events happening at the same time. Because each eventID is unique, even if the same user was running two events at the exact same time, with the same featured products, accurate reporting and order and payment allocation are provided. Additionally, when a reservation is converted in to an order, the reservation record within the database is updated to contain the orderID, thus tying together all orders from an event 109.

FIG. 9 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 9, an exemplary system for implementing aspects described herein includes a computing device, such as computing device 900. In its most basic configuration, computing device 900 typically includes at least one processing unit 902 and memory 904. Depending on the exact configuration and type of computing device, memory 904 may be volatile (such as random access memory (RAM)), non-volatile (such as read-only memory (ROM), flash memory, etc.), or some combination of the two. This most basic configuration is illustrated in FIG. 9 by dashed line 906.

Computing device 900 may have additional features/functionality. For example, computing device 900 may include additional storage (removable and/or non-removable) including, but not limited to, magnetic or optical disks or tape. Such additional storage is illustrated in FIG. 9 by removable storage 908 and non-removable storage 910.

Computing device 900 typically includes a variety of computer readable media. Computer readable media can be any available media that can be accessed by the device 900 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 904, removable storage 908, and non-removable storage 910 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer storage media may be part of computing device 900.

Computing device 900 may contain communication connection(s) 912 that allow the device to communicate with other devices. Computing device 900 may also have input device(s) 914 such as a keyboard, mouse, pen, voice input device, touch input device, etc. Output device(s) 916 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, an event system comprises an admin application, a portal, and a database. The admin application comprises a plurality of templates and is configured to generate a micro-site or an embedded micro-site for an event using the templates as configured by a user device, wherein the micro-site or the embedded micro-site is accessible via a user website during a scheduled time, and wherein the admin application is configured to receive an order for a product. The portal is configured to receive information about the order for the product and transmit the information to a user device for fulfilment. The database is configured to store the schedule and the information about the order.

Implementations may include some or all of the following features. The micro-site is different from the user website and appears to be the user website, and the embedded micro-site appears within the user website. The admin application is further configured to provide the templates to the user device and receive at least one of the templates back from the user device with layout instructions and product information for use in generating the micro-site or the embedded micro-site, wherein the templates comprise a header template, a video template, a product template, and a footer template. The system further comprises a producer application configured to receive, from the admin application, stock allocations and sales data of the product being promoted while the event is running. The producer application is further configured to update the micro-site or the embedded micro-site while the event is running. The producer application is further configured to conclude the event pursuant to one of the schedule and a demand for the product while the event is running. The demand for the product is based on product view and event traffic data provided by the admin application to the producer application. The admin application is further configured to provide, to the user device through the portal, information of the product being promoted while the event is running.

In an implementation, an event method comprises receiving product information for an event at an event promotion system; creating a micro-site or an embedded micro-site for the event at the event promotion system using the product information, wherein the event is live promotion of a product, and wherein the micro-site or the embedded micro-site is controlled by the event promotion system and appears as a user website to a user accessing the user website; running the event over the micro-site or the embedded micro-site, wherein the event is accessible via the user website and via social media; receiving an order for the product over the micro-site or the embedded micro-site while the event is running; processing the order at the event promotion system; and outputting information about the order to a user device through a portal.

Implementations may include some or all of the following features. Running the event over a TV channel. Receiving a layout for the micro-site or the embedded micro-site and a plurality of templates from a user device, and creating the micro-site or the embedded micro-site using the layout and the templates. The templates comprise a header template, a video template, a product template, and a footer template. Creating the micro-site or the embedded micro-site comprises generating an event page to be displayed during the event, wherein the event page comprises product information for the product being promoted during the event. Providing data to a producer application of the event promotion system while the event is running, and updating event graphics on the micro-site or the embedded micro-site while the event is running based on the data. Providing real time product popularity information to the user device through the portal during the event. Providing product view and event traffic data to a producer application of the event promotion system while the event is running, and concluding the event based on a schedule or a demand determined using the product view and event traffic data. Promoting the event prior to running the event.

In an implementation, a system for promoting an event comprises: a system for promoting an event comprises: a processor for generating a micro-site for an event using product information and layout information received from a user device, wherein the micro-site is separate from, but accessible by, a user website and wherein the micro-site appears to be the user website to a user device that accesses the event through the user website or through social media; and a memory for storing the schedule for the event.

Implementations may include some or all of the following features. The processor is further configured to provide information about the event, in real time during running of the event, to the user device and to a producer application. The system further comprises templates that are provided to the user device for selection for use in generating the micro-site.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. An event system comprising:
an admin application comprising a plurality of templates and configured to generate a micro-site or an embedded micro-site for an event using the templates as configured by a user device, wherein the micro-site or the embedded micro-site is accessible via a user website during a scheduled time, and wherein the admin application is configured to receive an order for a product;
a portal configured to receive information about the order for the product and transmit the information to a user device for fulfilment; and
a database configured to store the schedule and the information about the order.

2. The system of claim 1, wherein the micro-site is different from the user website and appears to be the user website, and wherein the embedded micro-site appears within the user website.

3. The system of claim 1, wherein the admin application is further configured to provide the templates to the user device and receive at least one of the templates back from the user device with layout instructions and product information for use in generating the micro-site or the embedded micro-site, wherein the templates comprise a header template, a video template, a product template, and a footer template.

4. The system of claim 1, further comprising a producer application configured to receive, from the admin application, stock allocations and sales data of the product being promoted while the event is running.

5. The system of claim 4, wherein the producer application is further configured to update the micro-site or the embedded micro-site while the event is running.

6. The system of claim 4, wherein the producer application is further configured to conclude the event pursuant to one of a) the schedule and b) a demand for the product while the event is running.

7. The system of claim 6, wherein the demand for the product is based on product view and event traffic data provided by the admin application to the producer application.

8. The system of claim 1, wherein the admin application is further configured to provide, to the user device through the portal, information of the product being promoted while the event is running.

9. An event method comprising:
receiving product information for an event at an event promotion system;
creating a micro-site or an embedded micro-site for the event at the event promotion system using the product information, wherein the event is live promotion of a product, and wherein the micro-site or the embedded micro-site is controlled by the event promotion system and appears as a user website to a client accessing the user website;
running the event over the micro-site or the embedded micro-site, wherein the event is accessible via the user website and via social media;
receiving an order for the product over the micro-site or the embedded micro-site while the event is running;
processing the order at the event promotion system; and
outputting information about the order to a user device through a portal.

10. The method of claim 9, further comprising running the event over a TV channel.

11. The method of claim 9, further comprising receiving a layout for the micro-site or the embedded micro-site and a plurality of templates from a user device, and creating the micro-site or the embedded micro-site using the layout and the templates.

12. The method of claim 11, wherein the templates comprise a header template, a video template, a product template, and a footer template.

13. The method of claim 9, wherein creating the micro-site or the embedded micro-site comprises generating an event page to be displayed during the event, wherein the event page comprises product information for the product being promoted during the event.

14. The method of claim 9, further comprising providing data to a producer application of the event promotion system while the event is running, and updating event graphics on the micro-site or the embedded micro-site while the event is running based on the data.

15. The method of claim 9, further comprising providing real time product popularity information to the user device through the portal during the event.

16. The method of claim 9, further comprising providing product view and event traffic data to a producer application of the event promotion system while the event is running, and concluding the event based on a schedule or a demand determined using the product view and event traffic data.

17. The method of claim 9, further comprising promoting the event prior to running the event.

18. A system for promoting an event, the system comprising:
a processor for generating a micro-site for an event using product information and layout information received from a user device, wherein the micro-site is separate from, but accessible by, a user website and wherein the micro-site appears to be the user website to a user device that accesses the event through the user website or through social media; and
a memory for storing the schedule for the event.

19. The system of claim 18, wherein the processor is further configured to provide information about the event, in real time during running of the event, to the user device and to a producer application.

20. The system of claim 18, further comprising templates that are provided to the user device for selection for use in generating the micro-site.
